(19) United States
(12) Patent Application Publication
(10) Pub. No.: US 2010/0071704 A1
(43) Pub. Date: Mar. 25, 2010

(54) MEDICAL DEVICE FOR SUPPORTING LIMBS

(76) Inventor: Adrian Domondon, Flushing, NY (US)

Correspondence Address: Russ Weinzimmer, 614 Nashua Street, Suite 53, Milford, NH, 03055, US

(21) Appl. No.: 12/234,628

(22) Filed: Sep. 20, 2008

(51) Int. Cl. A61G 15/00

(52) U.S. Cl. 128/845

(57) ABSTRACT

A medical device and method of use thereof are disclosed for supporting a patient's limb during surgical preparation and/or other medical procedures. The limb support device includes a V-shaped apparatus that is attachable to a supporting pole, such as a pole attached to a patient support structure or an IV pole standing on the floor. A clamp can be included to attach the apparatus to the pole. In preferred embodiments the vertical height, horizontal extension, and/or rotational angle of the apparatus can be adjusted. A cushion can be built into, or removably attachable to, the limb support apparatus, and a disposable sterile covering can be applied to the device before it is used. A preferred method of use includes placing a patient on a support structure, providing and appropriately configuring the limb support device, and placing the patient's limb on the device for surgical preparation and/or some other medical procedure.

### FIELD OF THE INVENTION

This invention relates to medical devices and methods, and in particular to devices and methods for supporting limbs of medical patients.

### BACKGROUND OF THE INVENTION

Medical personnel frequently need to support or suspend a patient's arm or leg while preparing the arm or leg for surgery. In particular, medical providers often prepare a patient's arm or leg for surgery by applying a disinfectant to the entire surface of the arm or leg, so as to cleanse and disinfect the arm or leg just before the operation. This stage of surgical preparation requires that the limb be supported or suspended in the air, so that the entire surface of the limb is accessible, and so that the disinfectant can be applied without the limb being in contact with any non-sterile surfaces. This raises the classic “Achilles heel” dilemma, wherein it is difficult or impossible to cleanse and/or apply disinfectant to the area of the limb that makes contact with the supporting or suspending mechanism.

One common method of preparing a patient's leg before surgery is to suspend the patient's foot from an IV pole using strips of gauze attached between the IV pole and a few of the patient's toes. While this approach minimizes the area of contact with the limb, it can potentially be harmful to a patient who is compromised, such as with diabetes or a vascular condition, and it can possibly cause nerve damage to an otherwise healthy patient.

Other methods for suspending a limb during the application of disinfectant employ devices that make contact with the limb over an undesirably large area, and allow too much freedom for the limb to shift in position while the disinfectant is being applied, thereby causing the area of contact between the device and the limb to change and shift during preparation.

### SUMMARY OF THE INVENTION

A device for supporting a limb during preparation for surgery is claimed that makes minimal contact with the limb while supporting the limb from below in a manner that maintains the limb in a fixed position and is not dangerous to the health of the limb, even for compromised patients. The limb support device includes a narrow, V-shaped support that maintains the limb in the notch of the “V,” thereby safely and securely supporting the limb while minimizing the area of contact between the supporting device and the limb.

The V-shaped limb support device is attachable to a pole, which can be an IV pole, or a pole attached to a patient support structure such as a surgical table or gurney. The device can be adjusted according to its height, lateral extension, and/or rotational angle relative to the pole. A method of use of the limb support device is also claimed, including placing a patient on a patient support structure, configuring the limb supporting apparatus so as to support a patient's limb, and placing the limb onto the V-shape of the limb supporting apparatus in a manner such that the limb is supported above the patient support structure.

One general aspect of the invention is a device for supporting a limb during preparation for surgery, including a limb supporting apparatus connected to or attachable to a cooperative supporting pole, where the limb supporting apparatus includes two straight segments joined end-to-end at an angle, so as to form a V-shape with the vertex of the angle pointed downward. In preferred embodiments the supporting pole is attachable to a patient support structure and/or able to stand on the floor. In some preferred embodiments the limb support device is attachable to an IV pole, and/or a supporting pole that is attachable to a patient support structure. In other preferred embodiments, the limb supporting apparatus is capable of supporting a human leg near the foot when the limb supporting apparatus is attached to the supporting pole, and/or a human arm, for example underneath the humerus bone.

In preferred embodiments, the limb support device is attachable to the supporting pole by means of a clamp that includes a screw capable of being tightened against the supporting pole, such as a butterfly screw for example. In certain preferred embodiments, the positioning of the limb support device when attached to the supporting pole is adjustable according to an attachment location of the limb support device along the supporting pole, a degree of extension of the limb supporting apparatus from the supporting pole, and/or a rotational angle of the limb supporting apparatus relative to the supporting pole.

In preferred embodiments, the limb support device further comprises a cushion, such as a gel pad, for example, which is either connected to, or removably attachable to, the limb supporting apparatus. In other preferred embodiments, the limb support device includes a sterile covering that is removably attachable to the limb support apparatus, and is able to prevent direct contact between a supported limb and the device. In certain of these embodiments the sterile covering is disposable.

Another general aspect of the invention is a device for supporting a limb during preparation for surgery, the device comprising a limb supporting apparatus attachable to an IV pole, the limb supporting apparatus including a narrow, protruding structure that supports the limb from below while making minimal physical contact with the limb. In some preferred embodiments, the limb supporting apparatus is capable of supporting a human leg near the foot when the limb supporting apparatus is attached to the IV pole.

In preferred embodiments, the limb support device is attachable to the IV pole by means of a clamp that includes a screw capable of being tightened against the supporting pole. In certain preferred embodiments, the positioning of the limb support device when attached to the IV pole is adjustable according to an attachment location of the limb support device along the IV pole, a degree of extension of the limb supporting apparatus from the IV pole, and/or a rotational angle of the limb supporting apparatus relative to the IV pole.

In some preferred embodiments, the limb support device further comprises a cushion, such as a gel pad, for example, which is either connected to, or removably attachable to, the limb supporting apparatus. In other preferred embodiments, the device includes a sterile covering that is removably attachable to the limb support apparatus, and is able to prevent direct contact between a supported limb and the device. In some of these preferred embodiments the sterile covering is disposable.

Another general aspect of the invention is a method for supporting a limb of a patient during preparation for surgery. The method begins with the step of placing a patient on a patient support structure, and providing a limb supporting apparatus that is attachable to a supporting pole, the limb supporting apparatus including two straight segments joined end-to-end at an angle, so as to form a V-shape with the vertex of the angle pointed downward. Next, the limb supporting apparatus is configured such that it is supported by the supporting pole and located near the patient support structure in a location and orientation that allows a limb of the patient to be placed upon and supported by the limb supporting apparatus. Finally, the limb of the patient is placed onto the V-shape of the limb supporting apparatus, such that the limb is supported above the patient support structure, and can be safely and effectively prepped for surgery or can undergo some other medical procedure.

### BRIEF DESCRIPTION OF THE DRAWINGS

The invention will be more fully understood by reference to the detailed description, in conjunction with the following figures, wherein:

FIG. 1A is a side view of a preferred embodiment of the device, where the device is attached to a pole by means of a clamp and a butterfly screw;

FIG. 1B is a top view of the embodiment of FIG. 1A;

FIG. 2 illustrates the embodiment of FIG. 1A being used to support a supine patient's right leg from beneath the heel;

FIG. 3 illustrates three preferred embodiments of the device positioned near an operating table, two of the embodiments being attached to poles fixed to the operating table, and the third embodiment being attached to an IV pole standing on the floor;

FIG. 4A is a side view of a preferred embodiment attached to a pole, wherein the vertical positioning of the device is adjustable;

FIG. 4B is a side view of the preferred embodiment of FIG. 4A, wherein the vertical position of the device has been adjusted upwards;

FIG. 5A is an oblique side view of a preferred embodiment wherein the limb supporting apparatus is attached to a pole via a clamp, and is horizontally extendable;

FIG. 5B is an oblique side view of the preferred embodiment of FIG. 5A, wherein the limb supporting apparatus has been horizontally extended outward from the pole;

FIG. 6A is an oblique side view of a preferred embodiment wherein the limb supporting apparatus is attached to a pole via a clamp, and wherein the limb supporting apparatus can be rotated;

FIG. 6B is an oblique side view of the preferred embodiment of FIG. 6A, wherein the limb supporting apparatus has been rotated to a different angle as compared to FIG. 6A;

FIG. 7A illustrates a preferred embodiment of a sterile covering that can be removably attached to the device so as to surround the limb supporting apparatus;

FIG. 7B illustrates the preferred embodiment of FIG. 7A with the sterile covering attached to the device and surrounding the limb supporting apparatus; and

FIG. 8 is a flow diagram illustrating a preferred embodiment of the method of the invention in which the device is attached to a pole and used to support a patient's limb during preparation for surgery.

### DETAILED DESCRIPTION OF PREFERRED EMBODIMENTS

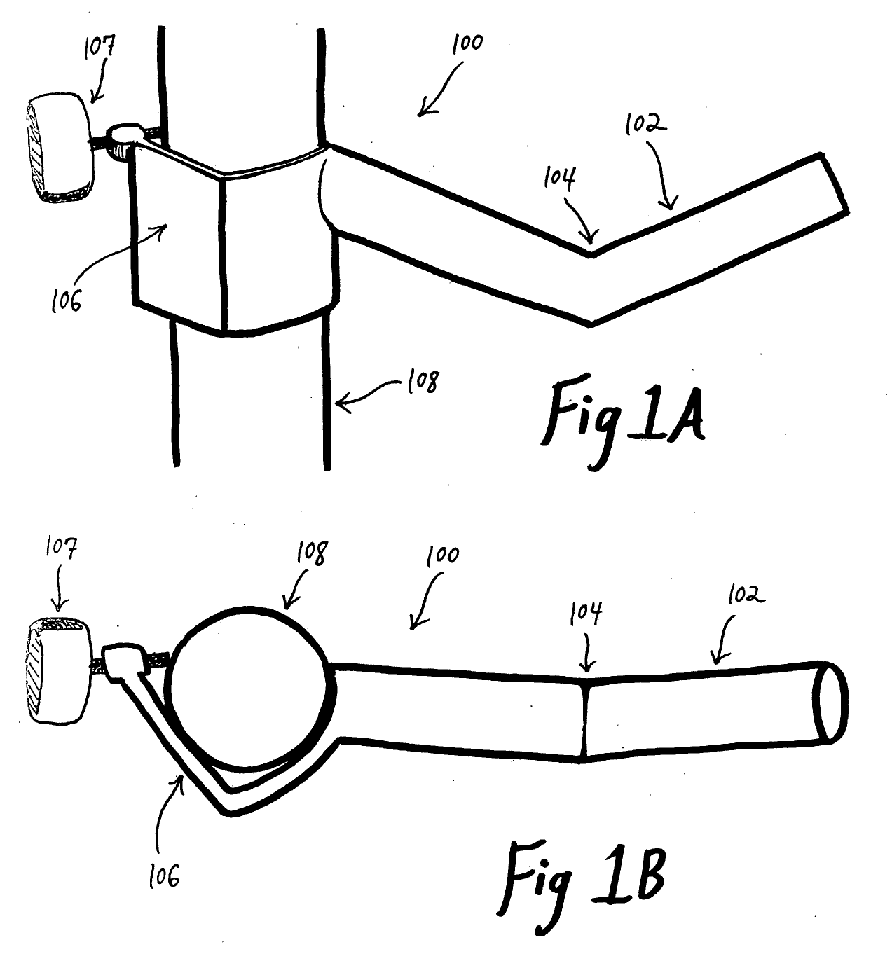

With reference to FIG. 1A, the present invention is a device 100 for supporting a limb during preparation for surgery. The device includes a limb supporting apparatus 102 that is at least attachable to a supporting pole 108. The limb supporting apparatus 102 includes two straight segments joined end-to-end at an angle, so as to form a V-shape, with the vertex of the angle pointed downward. A patient's limb can be placed in the notch 104 at the middle of the limb supporting apparatus 102 and can thereby be supported by the device 100. FIG. 1A is a side view illustrating a preferred embodiment in which the device is attached to the pole 108 by means of a clamp 106 and a butterfly screw 107. In this embodiment, the apparatus 102 has a cylindrical cross section. FIG. 1B is a top view of the preferred embodiment of FIG. 1A. In FIG. 1B, it can be seen that the butterfly screw 105 is tightened against the pole 106.

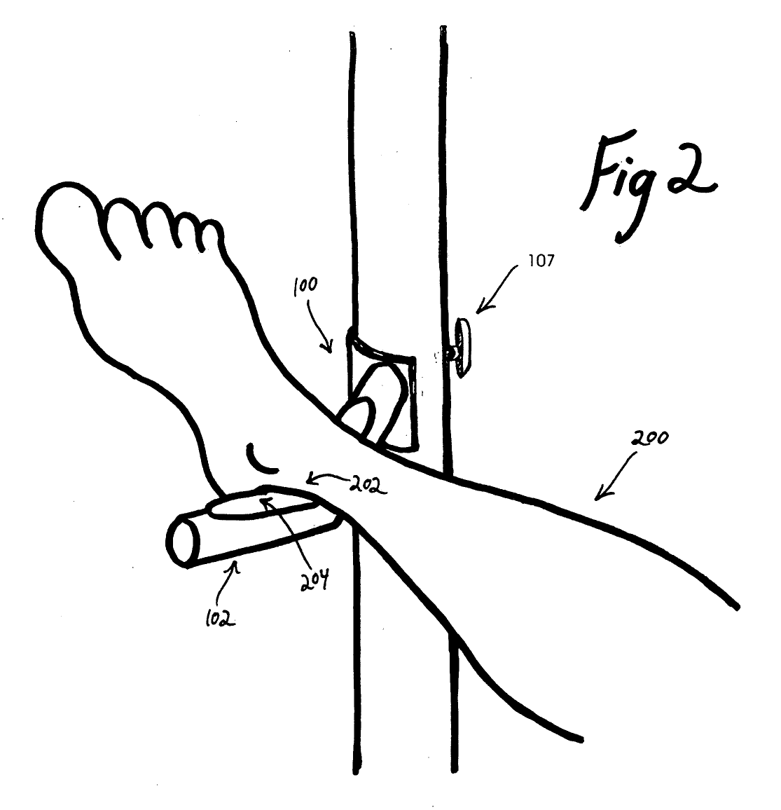

FIG. 2 shows an embodiment similar to the embodiment of FIG. 1A and FIG. 1B supporting a supine patient's right leg 200 from beneath the heel 202. The patient's leg 200 is slightly raised, and the heel 202 is resting in the notch 104 of the limb supporting apparatus 102. The embodiment of FIG. 2 includes a cushion 204 built into the upper surface of the limb supporting apparatus 102, which cushions the patient's heel 202 and keeps it out of direct contact with the rigid frame of the limb supporting apparatus 102. In similar embodiments, the cushion 204 is removably attachable to the apparatus 102. The limb support device 100 is attached to a pole 108, which can be either a supporting pole attached to a patient support structure, or an IV pole that stands on the ground.

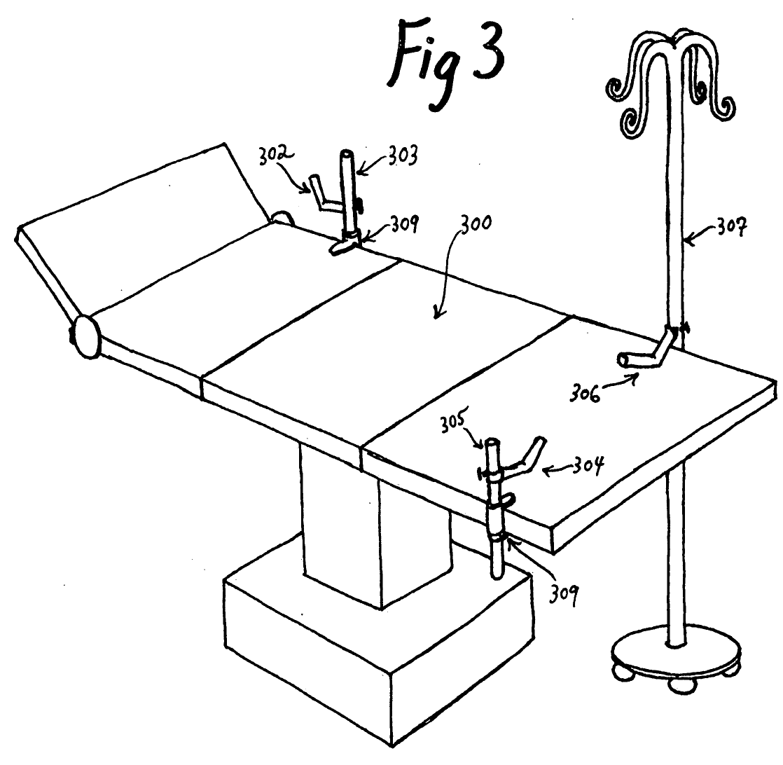

FIG. 3 shows three preferred embodiments of the device positioned near an operating table 300, wherein two of the embodiments 302, 304 are attached to supporting poles 303, 305 that are fixed to the operating table 300, while the third embodiment 306 is attached to an IV pole 307 that is standing on the floor. A limb support device configured to support a patient's left arm 302 is shown attached to a supporting pole 303 which is fixed to the operating table 300. A clamp 309 can be used to fix the supporting pole 303, 305 to the operating table 300, as shown in FIG. 3, or a bracket or other suitable temporary or permanent attachment means can be used. Another limb support device 304 configured to support a patient's right leg is shown attached to another supporting pole 305 which is also attached to the operating table 305 by a clamp 309. A third limb support device 306 configured to support a patient's left leg is shown attached to an IV pole 307 that is standing on the floor adjacent to the side of the operating table 300.

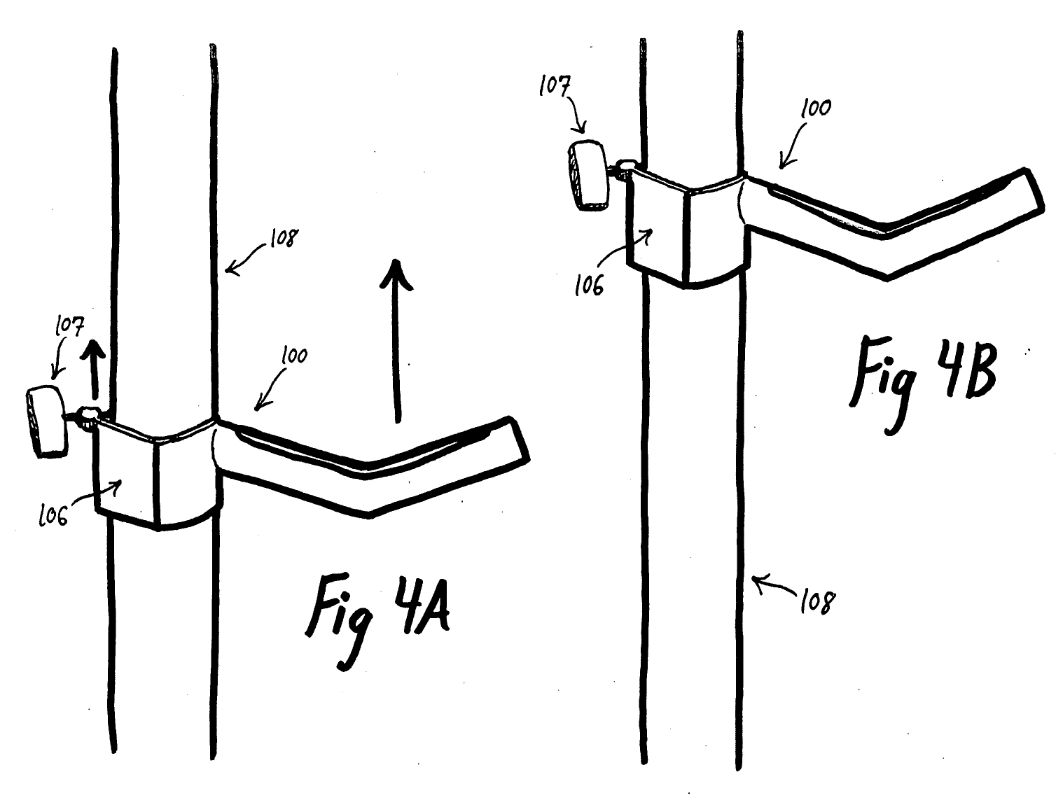

FIG. 4A is a side view of a preferred embodiment in which the limb support device 100 is attached to a pole 108 and its location on the pole 108 can be adjusted up or down. In the figure, the limb support device 100 is fixed to the pole 108 by a clamp 106 which includes a butterfly screw 107. The butterfly screw 107 can be loosened, and the clamp 106 can be slid up or down along the pole 108. FIG. 4B is a side view of the preferred embodiment of FIG. 4A in which the limb support device 100 has been moved upwards on the pole 108.

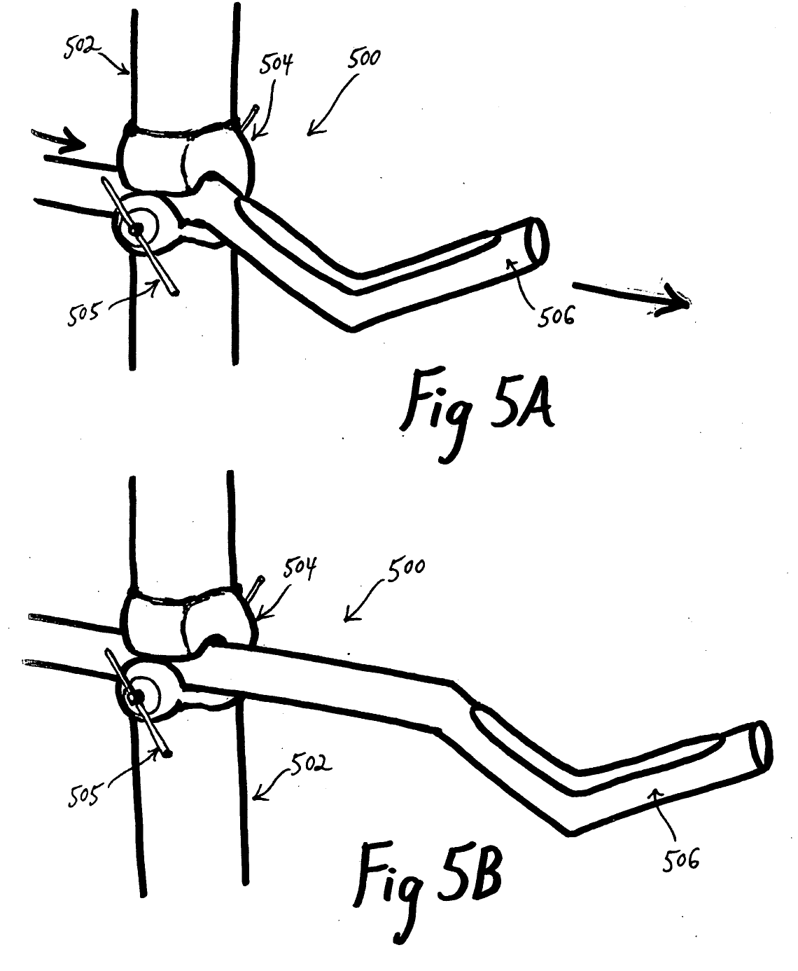

FIG. 5A is an oblique side view of a preferred embodiment in which the limb support device 500 is attached to a pole 502 by a clamp 504 that allows the device 500 to be horizontally extended. In the figure, a limb supporting apparatus 506 is affixed in a perpendicular orientation relative to the pole 502 by a clamp 504 that includes a butterfly screw 503 that is in contact with the pole 502, and another butterfly screw 505 that is in contact with the limb supporting apparatus 506. When the butterfly screw 505 in contact with the limb supporting apparatus 506 is tightened, the limb supporting apparatus 506 is firmly fixed in the clamp 504. When the butterfly screw 505 in contact with the limb supporting apparatus 506 is loosened, the limb supporting apparatus 506 can be slid farther from or closer to the pole 502. FIG. 5B is an oblique side view of the preferred embodiment of FIG. 5A, with the horizontal position of the limb support apparatus 506 extended farther outwards from the pole 502.

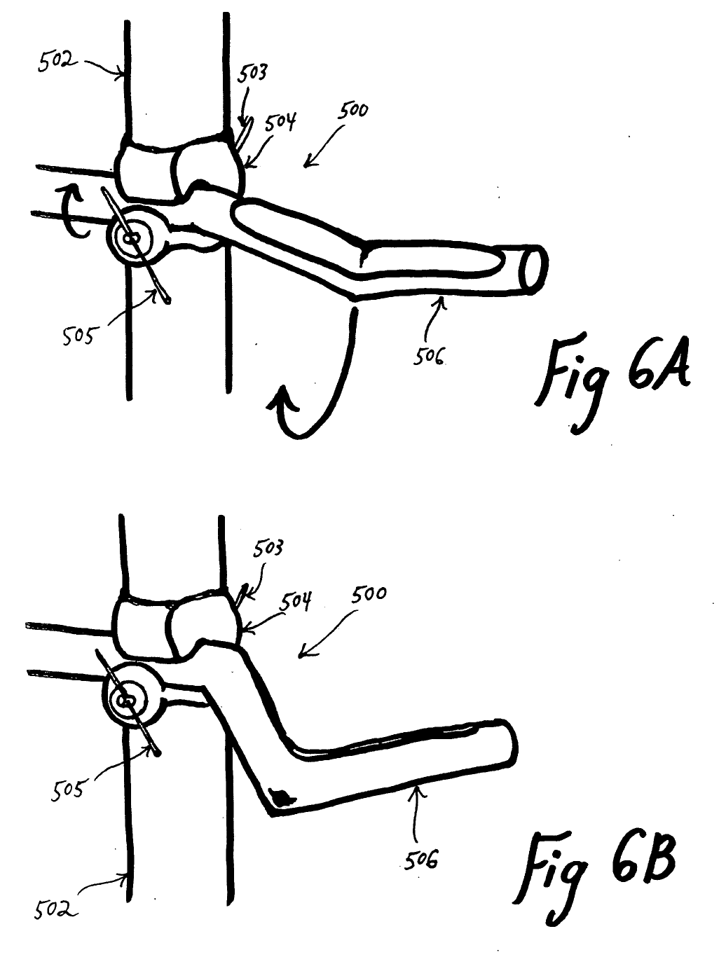

FIG. 6A is an oblique side view of a preferred embodiment in which the limb support device 500 is attached to a pole 502 by a clamp 504 that allows the limb support device 500 to be rotated. In the figure, a limb supporting apparatus 506 is affixed in a perpendicular orientation relative to the pole 502 by a clamp 504 that includes a butterfly screw 503 that is in contact with the pole 502, and another butterfly screw 505 that is in contact with the limb supporting apparatus 506. When the butterfly screw 505 in contact with the limb supporting apparatus 506 is tightened, the limb supporting apparatus 506 is firmly fixed in the clamp 504. When the butterfly screw 505 is loosened, the limb supporting apparatus 506 can be turned about its axis. FIG. 6B is an oblique side view of the preferred embodiment of FIG. 6A, with the angular orientation of the supporting apparatus 506 rotated as compared to the orientation shown in FIG. 6A.

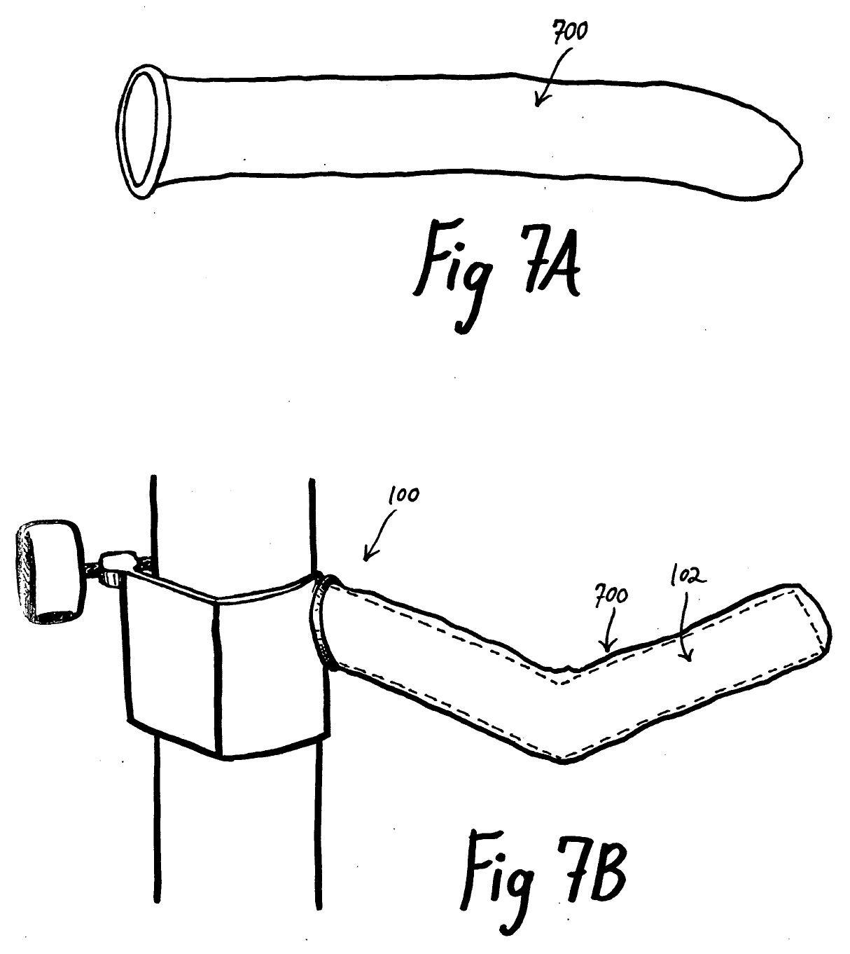

FIG. 7A illustrates a preferred embodiment that includes a sterile covering 700 that is able to surround a limb supporting apparatus 102. In the embodiment of FIG. 7A the sterile covering 700 is a tubular sleeve, similar to a condom. In some preferred embodiments the sterile covering 700 is made of a disposable material, such as paper or latex. In other preferred embodiments, the covering 700 is a sterile towel, or any other means of providing a sterile layer of protection between a patient's limb and the limb supporting apparatus 102. FIG. 7B shows the preferred embodiment of FIG. 7A attached to and surrounding the limb supporting apparatus 102 of a limb support device 100. In preferred embodiments the sterile covering 700 can be disposed of after use, and a new sterile covering 700 can be applied for each successive usage of the limb support device 100.

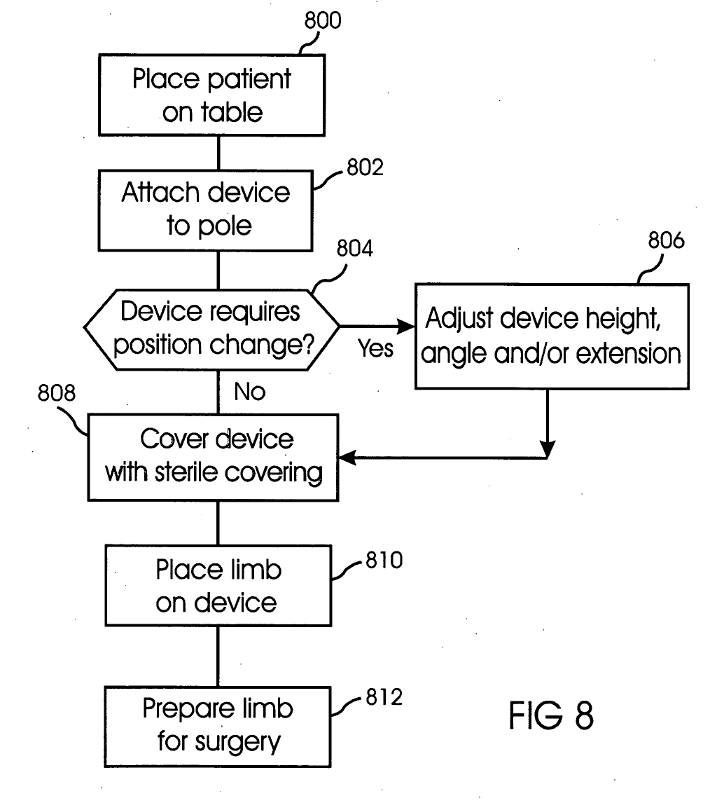

FIG. 8 is a flow diagram illustrating a preferred method of using the device 100 of the present invention, in which the device is configured and used to support a patient's limb during preparation for surgery. A patient is placed on an operating table or other patient support structure 800 and the limb support device is attached to a pole 802. If the device is not properly positioned 804, the vertical height, orientation angle, and/or horizontal extension 806 are adjusted. In preferred embodiments the device is then covered with a disposable sterile covering 808, such as a towel or a paper or latex sleeve. A patient's limb is placed securely on the device 810, and the limb is prepared for surgery 812. The limb support device can also be used for non-surgical applications, such as for suturing or other non-surgical procedures.

Other modifications and implementations will occur to those skilled in the art without departing from the spirit and the scope of the invention as claimed. Accordingly, the above description is not intended to limit the invention except as indicated in the following claims.

What is claimed is:

1. A device for supporting a limb during preparation for surgery, the device comprising a limb supporting apparatus at least attachable to a supporting pole, the limb supporting apparatus including two straight segments joined end-to-end at an angle, so as to form a V-shape with the vertex of the angle pointed downward.

2. The device of claim 1, further comprising a supporting pole cooperative with the limb supporting apparatus.

3. The device of claim 2, wherein the supporting pole is at least one of:
attachable to a patient support structure; and
standable on the floor.

4. The device of claim 1, wherein the device is attachable to an IV pole.

5. The device of claim 1, wherein the limb supporting apparatus is capable of supporting a human leg near the foot of the leg when the limb supporting apparatus is attached to the supporting pole.

6. The device of claim 1, further comprising a clamp that is able to attach the limb supporting apparatus to the supporting pole.

7. The device of claim 6, wherein the clamp includes a screw capable of being tightened against the supporting pole.

8. The device of claim 1, wherein positioning of the supporting apparatus when attached to the supporting pole can be adjusted according to at least one of:
an attachment location of the limb supporting apparatus along the supporting pole;
a degree of extension of the limb supporting apparatus outward from the supporting pole; and
a rotational angle of the limb supporting apparatus relative to the supporting pole.

9. The device of claim 1, wherein the limb supporting apparatus further comprises a cushion that is one of connected to, and removably attachable to, the limb supporting apparatus.

10. The device of claim 9, wherein the cushion is a gel pad.

11. The device of claim 1, further comprising a protective covering that is removably attachable to the device and is able to prevent direct contact between a supported limb and the device.

12. The device of claim 11, wherein the protective covering is at least one of disposable and sterile.

13. A device for supporting a limb during preparation for surgery, the device comprising a limb supporting apparatus attachable to an IV pole, the limb supporting apparatus including a narrow, protruding structure that supports the limb from below while making minimal physical contact with the limb.

14. The device of claim 13, wherein the limb supporting apparatus is capable of supporting a human leg near the foot when the limb supporting apparatus is attached to the IV pole.

15. The device of claim 13, wherein the limb supporting apparatus is attachable to the IV pole by means of a clamp that includes a screw capable of being tightened against the supporting pole.

16. The device of claim 13, wherein positioning of the supporting apparatus when attached to the IV pole can be adjusted according to at least one of:
an attachment location of the limb supporting apparatus along the IV pole;
a degree of extension of the limb supporting apparatus outward from the IV pole; and
a rotational angle of the limb supporting apparatus relative to the IV pole.

17. The device of claim 13, wherein the limb supporting apparatus further comprises a cushion that is one of connected to, and removably attachable to, the limb supporting apparatus.

18. The device of claim 17, wherein the cushion is a gel pad.

19. The device of claim 13, further comprising a protective covering that is removably attachable to the device and is able to prevent direct contact between a supported limb and the device.

20. A method for supporting a limb of a patient during preparation for surgery, the method comprising:
placing the patient on a patient support structure;
providing a limb supporting apparatus that is at least attachable to a supporting pole, the limb supporting apparatus including two straight segments joined end-to-end at an angle, so as to form a V-shape with the vertex of the angle pointed downward;
configuring the limb supporting apparatus such that it is supported by a supporting pole and located near the patient support structure in a location and orientation that allows a limb of the patient to be placed upon and supported by the limb supporting apparatus; and
placing the limb of the patient onto the V-shape of the limb supporting apparatus, such that the limb is supported above the patient support structure.
